(19) United States
(12) Patent Application Publication
(10) Pub. No.: US 2017/0323232 A1
(43) Pub. Date: Nov. 9, 2017

(54) System and Methods for Reporting and Managing Incidents Using Electronic Devices

(71) Applicant: Lexmark International Technology Sarl, Meyrin (CH)

(72) Inventor: Michael Todd Wessel, Lenexa, KS (US)

(21) Appl. No.: 15/583,790

(22) Filed: May 1, 2017

Related U.S. Application Data
(60) Provisional application No. 62/329,900, filed on Apr. 29, 2016.

(51) Int. Cl. G06Q 10/06; G06Q 50/26

(52) U.S. Cl. CPC G06Q 10/0631; G06Q 50/265

(57) ABSTRACT

A method of managing a report for an incident via a remote server that includes receiving an indication of an occurrence of an incident from a first electronic device; receiving information for the generation of an incident report from at least two electronic devices; storing the information in a storage location associated with the incident; determining if the stored information includes all information required to generate a complete incident report; upon a negative determination, transmitting an indication of the stored information and of information needed required to generate the complete incident report to at least one electronic device of the plurality electronic devices; and upon a positive determination, changing the state of the storage location associated with the incident and generating the incident report from the stored information associated with the incident.

### CROSS REFERENCE TO RELATED APPLICATIONS

This patent application claims the benefit of the earlier filing date of U.S. provisional patent application Ser. No. 62/329,900, entitled “System and Methods for Reporting and Managing Incidents Using Electronic Devices,” filed Apr. 29, 2016, the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present disclosure relates to incident reporting systems and, more particularly, to reporting retail incidents using multiple electronic devices.

### 2. Description of the Related Art

Retailers are frequently faced with a range of costly incidents across their locations. An incident may be any event or occurrence that results in a loss of time and/or material resources for a store, establishment or company, such as theft, return fraud as well as customer and employee accidents. Retailers are subject to a number of requirements in order to not only stay in operation, but also to ensure employee and customer safety and satisfaction.

Retailers are required to implement a method to receive reports of financially-related misconduct including injuries and theft incidents by employees. Employers are required to provide a safe and healthy work environment. The Sarbanes-Oxley Act of 2002 requires organizations to implement an anonymous method by which to receive reports of financially related misconduct or concerns. Claims, lost workdays and OSHA fines cost the retail industry hundreds of millions of dollars every year. Retailers are required to provide a safe shopping environment for customers. However, when accidents do happen, mishandled cases can cost the retailer, not only in monetary damages, but also in public perception.

Reporting and documenting any incidents can be resource and time-intensive, taking store employees away from customer service and sales. Most retailers typically have an incident management or investigation system that requires employees to fill out forms, whether paper or electronic, to obtain basic information about the incident. Some chain retailers have a hotline for employees to call in the event of an incident in a particular store. In either case, the forms may be handed to authorized personnel for manual entry into the retailer's incident management system.

With these incident management systems, reporting is often not real time, or even near real-time, due to a number of reasons, including employees having limited access to the incident management system. For example, there is usually only one computer per store capable of running the incident management application; access to the incident management system may be in the back office; and authorized loss prevention staff or store managers are often the only ones can access the incident management system. Incident data is, therefore, often not entered into the system until later when the store manager has time. On the other hand, some incident management systems utilize multiple devices, whether PCs or other electronic devices, for accessing the incident management system. While this might seem to be an advantage when it comes to reporting and information gathering, issues arise in the storage and retrieval of the information from multiple locations, such as, for example, some information stored on one device being overlooked by a person using another device.

Further, key information—such as incident forms, customer/employee interviews, photos and videos—is often not captured immediately and/or processed as soon as those key information becomes available, resulting in an incomplete view of the case. For example, at the end of a work shift, a store manager may be entering data to create a report about an incident that occurred earlier in the day. The manager may realize that he needs a piece of information (e.g., a photo, witness statement, etc.) to complete the report. Since the manager is creating the report at the end of the work shift, the site of the incident may have already been cleaned up, and employees present when the incident occurred may not be available to provide a photo. The manager then has to contact the employees present during the incident, whether by phone or email, to ask whether any of the employees captured a photo, and if so, to have the employee send in the photo they captured. Given that the employees may already off work, they may not immediately respond, resulting in further delay in completing the report. Also, even if an employee who has a photo responds immediately, the employee then needs to send the photo from the employee's device to the store computer, often via email. The manager then has to download it from the email inbox and attach or upload it into the incident management system. Further, if the manager is anticipating the email may no longer be at the store computer when the emailed photo arrives. If the emailed photo comes in while the manager is unaware or is logged out of the store PC, there may be a large number of emails that have also been received, thus resulting in the manager needing to search for that specific email. All this back and forth communication is essentially time lost in completing an incident report. If the employee had a mobile device with access to the incident management system, he/she may have just uploaded the needed photo directly into the system.

Most retailers are not efficient with processing the variety of “unstructured” evidence that is generated as part of the incident reporting process. Structured data such as store name, incident type, date, time and cost are usually recorded, but interview notes, signed witness statements, photos and video clips of the accident scene or damage, and confessions or witness statements are commonly in varying formats that may not centrally stored and, therefore, may not be associated with the incident. The resulting limited case information thus reduces the ability of personnel at the store, region and corporate level to gauge the completeness of the evidence required for such incidents or identify trends for revenue protection and risk mitigation.

Accordingly, a need exists for a system and methods for reporting and managing incidents that allow multiple users to report incidents in real time or near real time, allow multiple users to add evidence using multiple devices, and that stores all evidence in a central storage location or case file, for ease of access, retrieval and review.

### SUMMARY

A system and methods for managing incident reports are disclosed. One example method of managing a report for an incident via a remote server includes receiving an indication of an occurrence of an incident from a first electronic device; receiving information for the generation of an incident report from at least two electronic devices; storing the information in a storage location associated with the incident; determining if the stored information includes all information required to generate a complete incident report; upon a negative determination, transmitting an indication of the stored information and of information needed to generate the complete incident report to at least one of the electronic devices; upon a positive determination, changing the state of the storage location associated with the incident and generating the incident report from the stored information associated with the incident. In one example embodiment, the changing the state of the storage location includes indicating to at least one authorized user that the complete incident report is ready for review.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example embodiment of a networked system including a mobile device, a computer, a multi-function product and a remote server.

FIG. 2 is an example flowchart of one example method for enabling the remote server of FIG. 1 to manage the collection and storage of information pertaining to an incident for the completion of an incident report.

FIG. 3 is a user interface of the mobile device of FIG. 1 showing an application for creating and managing incident reports, according to one example embodiment.

FIG. 4 shows a list of required information for one of the incident reports created with the application of FIG. 3 as viewed on the user interface of the mobile device of FIG. 1, according to one example embodiment.

FIG. 5 shows a list of required information for one of the incident reports created with the application of FIG. 3 as viewed on the user interface of the multi-function product of FIG. 1, according to one example embodiment.

FIG. 6 shows a list of required information for one of the incident reports created with the application of FIG. 3 as viewed on the user interface of the computer of FIG. 1, according to one example embodiment.

FIG. 7 shows a completed list of required information for one of the incident reports created with the application of FIG. 3 as viewed on the user interface of the mobile device of FIG. 1, according to one example embodiment.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some example embodiments may be included in or substituted for those of others. The scope of the present application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity but rather denote the presence of at least one of the referenced item.

It will be further understood that each block of the example flowcharts or diagrams, and combinations of blocks in the example flowcharts or diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the description below.

These computer program instructions may also be stored in a non-transitory computer-readable memory that may direct a computer or other programmable data processing apparatus to function in a particular manner, such that the instructions stored in the computer-readable memory produce an article of manufacture, including an instruction means that implements the function specified in the block or blocks. The computer program instructions may also be loaded onto a computer or other programmable data processing apparatus to cause a series of operational actions or steps to be performed on the computer or other programmable apparatus to produce a computer implemented process such that the instructions that execute on the computer or other programmable apparatus implement the functions specified in the block or blocks.

Accordingly, blocks of the example flowcharts and diagrams support combinations of means for performing the specified functions, combinations of actions or steps for performing the specified functions and program instruction means for performing the specified functions. It will also be understood that each block of the diagrams, and combinations of blocks in the diagrams, may be implemented by special purpose hardware-based computer systems or combinations of special purpose hardware and computer instructions that perform the specified functions, actions or steps.

Disclosed is a method for transmitting an indication of an incident, managing the collection of information pertaining to the incident from multiple electronic devices, and storage of the same for the completion of the incident report via a remote server. According to one example embodiment of the present disclosure, a user may send an indication of the occurrence of an incident to a server using an application installed on a mobile device. The server then sends a list of required information and/or evidence to the mobile device as well as other electronic devices running the same application. Information and/or evidence regarding the incident may then be gathered or captured by the mobile device and the other devices and sent to the server. For example, photo evidence documenting the extent of damage or injury may be captured by the mobile device while a witness statement describing the details of the incident may be scanned using another electronic device, such as a multi-function product (MFP). The server receives this information and stores the received information in one folder or location for ease of access. The server then sends an updated list to all the electronic devices to indicate which information is still needed to complete an incident report. Upon receiving all the required information, the server changes the status of the folder to indicate that the folder contains information that comprise a complete incident report, and that the information as ready for review. In one example embodiment, the server may create an item on a user's task list informing the user that a review of the completed incident report is needed.

The system and method described herein may enable workflow solutions to easily access, retrieve and review information pertaining to an incident, as well as determine missing information for timely resolution and completion.

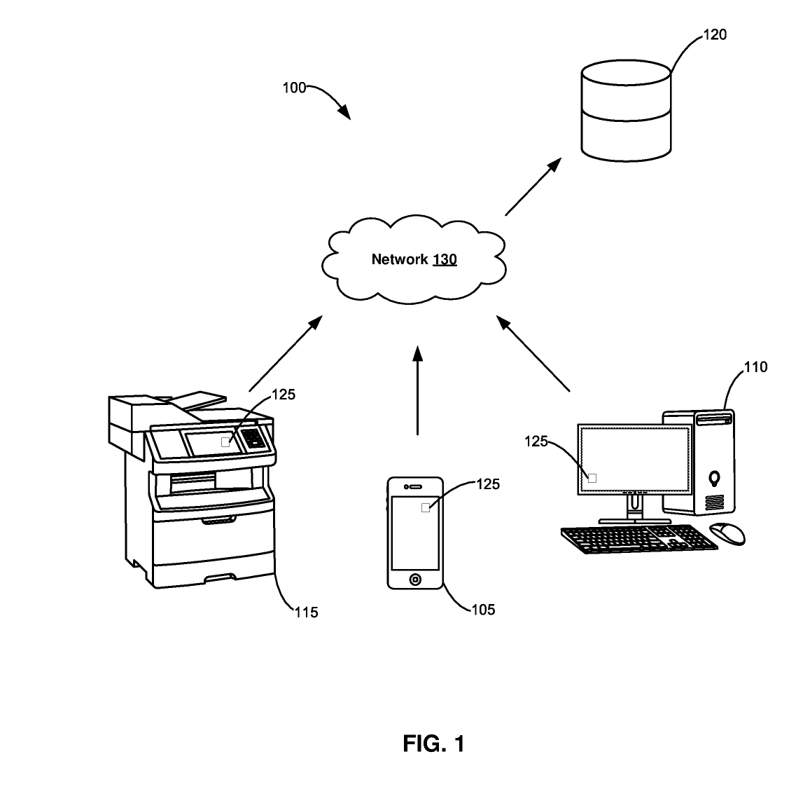

FIG. 1 is one example embodiment of a networked system 100, according to one example embodiment of the present disclosure. System 100 may be used in collecting information pertaining to an incident and storing said information in a remote storage location for the completion of an incident report. System 100 is a data communication system that may include a mobile device 105, a computer 110, multi-function product (MFP) 115, and a remote server 120, connected communicatively via network 130.

Mobile device 105 may be any computing device that is portable, handheld and/or pocket-sized such as, for example, a mobile device (e.g., a cell phone), a smart phone, a handheld computer, a personal digital assistant (PDA), a notebook computer, a tablet computer, or any other remote computing device, such as a special-purpose remote computing device (e.g., e-book reader). Mobile device 105 may include a display unit, an input functionality (e.g., keyboard), a processor, and memory, such as RAM, ROM, and/or NVRAM.

Additionally, mobile device 105 may include at least one control unit such as, for example, a processor (not shown) that controls the operation of mobile device 105. The control unit of mobile device 105 may include one or more embedded solutions that may allow a user of mobile device 105 to transmit an indication of an incident to remote server 120 via network 130, and to capture, store and transmit required information associated with the incident to server 120.

Computer 110 may be, for example, a personal or desktop computer. Computer 110 may include a display unit, an input device (e.g., keyboard), a processor, and memory, such as RAM, ROM, and/or NVRAM. Computer 110 may also include a mass data storage device, such as a hard drive, CD-ROM and/or DVD units. The processor may execute computer-executable program instructions stored in the memory. Computer-executable program instructions may include a set of instructions for executing application 125, such as, for example, an application for reporting incidents.

MFP 115 may be any multi-function printing device capable of performing other functions, such a faxing, e-mailing, scanning and/or copying, in addition to printing. MFP 115 may be network-enabled and capable of communicating with computer 110 and remote server 120. For example, MFP 115 may be connected to remote computer 110 and remote server 120 via a communication link, which may be established by a wired or wireless connection such as, for example, an Ethernet connection.

MFP 115 may be connected to network 130 by a direct cable or optical connection or by a network connection such as, for example, an Ethernet local area network (LAN). The connection between MFP 115 and network 130 may be established by an Internet connection, or via a wide area network (WAN). Communication links between MFP 115 and network 130 may be established by using standard electrical cabling or bus structures. The communication links may also be established using wireless connections. Where the communication links are wireless, MFP 115 may further include a radio transceiver. The wireless connection may be, for example, 2G, 3G, Bluetooth, CDMA, DECT, TDMA, UMTS-TDD, WiBro, WiFi, or WiMAX. Wired connections may be proprietary or constructed in accordance with a communications industry standard, such as USB or FireWire (IEEE-1394).

When used in a LAN networking environment, MFP 115 may be connected to the local area network through a network interface or adapter. When used in a WAN networking environment, MFP 115 may include a modem, T1 line, satellite or other means for establishing communications over a wide area network, such as the Internet. The modem, which may be internal or external, may be connected to a system bus of MFP 115 via a serial port interface.

Server 120 may be a computing device that hosts content for accessing by mobile device 105, computer 110 and MFP 115, through network 130. Examples of server 120 may include but are not limited to a personal computer, a server computer, a series of server computers, a mini computer, and a mainframe computer. Server 120 may include a database with one or more embedded solutions that may send a list of required information to mobile device 105, computer 110 and MFP 115, and to receive and store information and metadata related to and associated with an incident indicated by one of mobile device 105, computer 110 and MFP 115.

Application 125 may be a solution installed in mobile device 105, computer 110 and MFP 115. Application 125 may allow a user of mobile device 105, computer 110 and MFP 115 to send an indication of an incident, receive a list of required and optional information about the incident, capture the required and optional information in a variety of formats, and send the captured required information to server 120. Application 125 may be configured according to a capture functionality of each of mobile device 105, computer 110 and MFP 115. For example, application 125 installed on MFP 115 may support image capture from a scan bed of MFP 115 while application 125 installed on mobile device 105 may support image capture from a camera of mobile device 105. Alternatively, application 125 may be hosted in remote server 120 and may be accessible via mobile device 105, computer 110 and MFP 115 connected to network 130, as will be known in the art.

With continued reference to FIG. 1, network 130 may be any network, communications network, or network/communications network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein. Other types of networks and communications mode may be used to connect mobile device 105, MFP 115 and remote computer 110 from each other, as will be known in the art.

Although the system in FIG. 1 shows only one mobile device 105, one MFP 115, one computer 110 and one remote server 120, networked system 100 may have any number of components and devices, as will be appreciated by one of ordinary skill in the art.

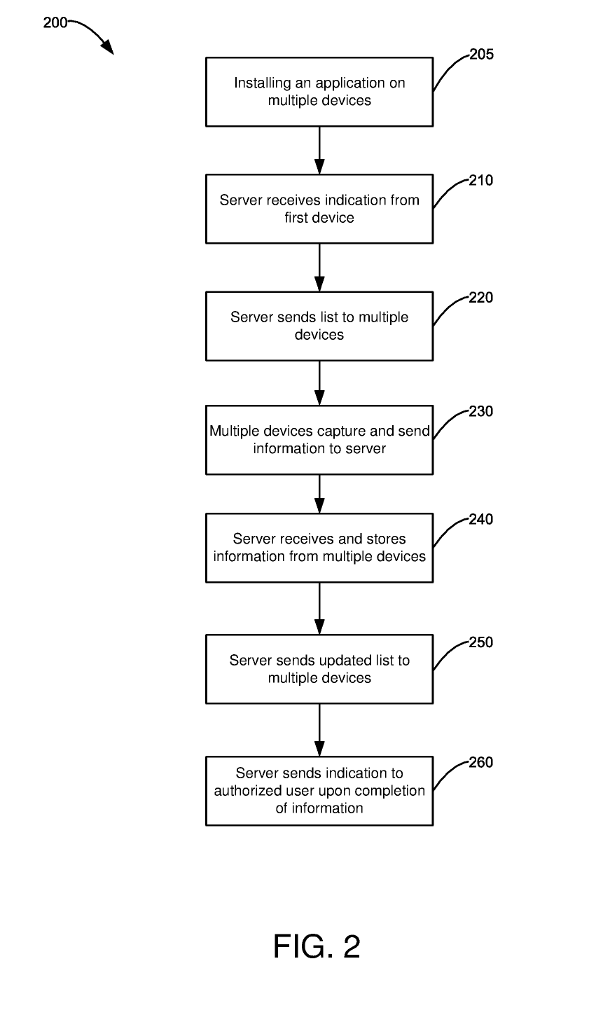

FIG. 2 shows one example method 200 for managing an incident report via remote server 120. For discussion purposes, blocks 205-260 indicate an example incident scenario involving an employee injury which will be used below to further describe method 200. In this example incident scenario, an employee has sustained an injury following a fall. It is to be understood that method 200 is not limited to such an example incident scenario and may be applied to other types of incidents, such as an external theft.

At block 205, application 125 may be accessed on a plurality of devices (e.g., mobile device 105, computer 110, and/or MFP 115). Users of the plurality of devices may a group of users expected to contribute information using application 125. For example, an establishment may require employees to install application 125 on personal mobile devices 105 to allow employees to report an incident or add information on any incident or case. In such example aspect, remote server 120 may cause application 125 to be loaded onto mobile device 105. Alternatively, an establishment may allow employees access to application 125 installed on remote server 120 via the employees' individual mobile devices 105. In some example aspects, the mobile devices may be owned and/or provided by the employer or establishment.

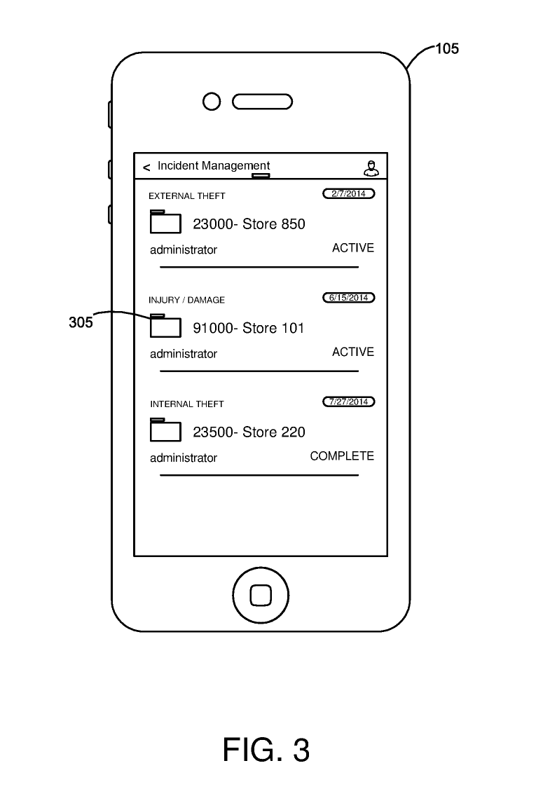

In the example incident scenario, an employee has sustained an injury after falling. As soon as the injured employee has been given first aid or taken to the nearest emergency medical facility, another employee may open application 125 on mobile device 105 and create a case folder 305 in application 125, as shown in FIG. 3. Opening application 125 may be accomplished by tapping an icon on the display of mobile device 105. Concurrent or subsequent to the creation of case folder 305, application 125 may also send an indication to server 120 that an incident has occurred.

At block 210, server 120 may receive the indication of the incident from a first device in system 100. For example, mobile device 105 may transmit the incident indication to server 120. In some example aspects, the first device may be computer 110 or MFP 115. The indication of the incident may include preliminary information, such as the date and time of the incident, and the type of incident, such as for example, theft. In some example embodiments, like the aforementioned example incident, the indication may be sent from mobile device 105 of a user on the site of the incident. In other example embodiments where a person who is on the site of the incident contacts an authorized user to report the incident, the indication may be sent from computer 110 of the authorized user.

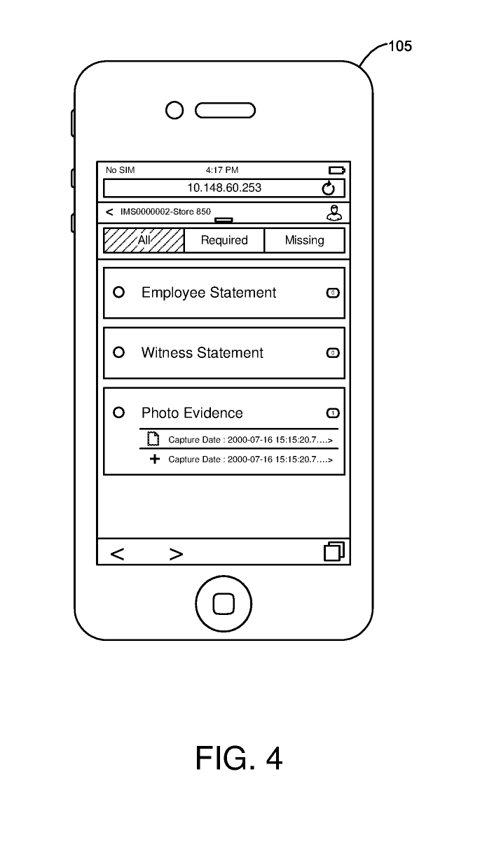

At block 220, server 120 may send a list of information required to complete an incident report to the plurality of devices, including the first device, through network 130. The information required to complete an incident report often varies depending on the type of incident being reported and consequently, the items on the list may also vary. As shown in FIGS. 4 through 6, the list may include items such as an Incident/Loss Notice, Employee Statement, Photo Evidence, and/or a Witness Statement among others. The list may have a preset number of items which may vary according to the type of incident being reported, and some items may or may not be marked as optional. In the example incident scenario, the list may further require items such as a Medical Certificate detailing the extent of the injury. As may be appreciated, the required items on the list may be configured to correspond not just to the reporting and documentation requirements of the establishment, but also to any required documentation for use outside of the establishment, say, to facilitate an insurance claim for example.

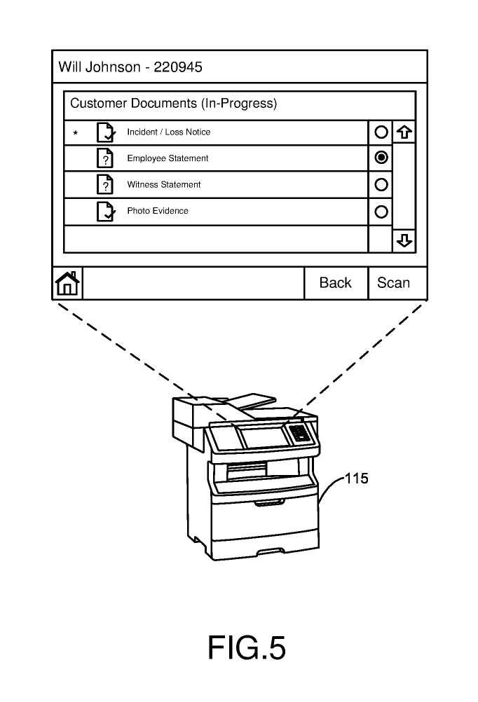

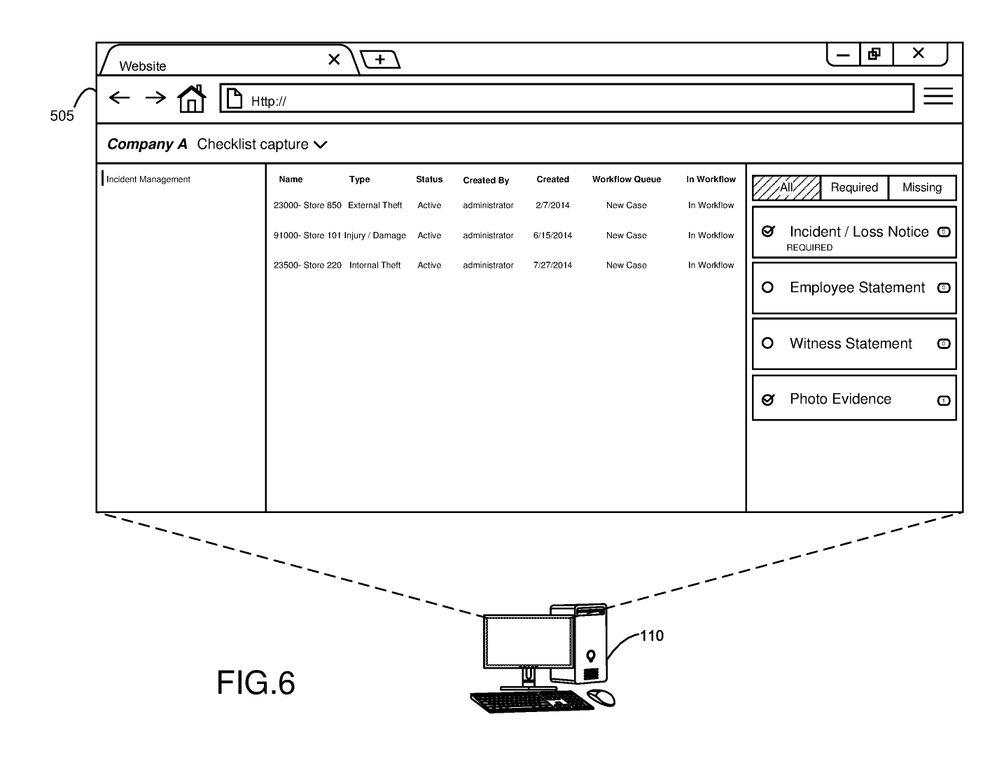

The same list of information may be viewed via the respective display interfaces of the plurality of devices. Seeing the same list across the plurality of devices allows the users of the plurality of devices to be informed on a real-time or near real-time basis of the state of completion of the information in case folder 305. FIGS. 4-6 show the same list as it would appear on mobile device 105, computer 110 and MFP 115, respectively, according to one example embodiment. FIG. 4 shows the list as it may appear in an application 125 running on mobile device 105, according to an example embodiment. FIG. 5 shows the incomplete list as it may appear on application 125 running on MFP 115. FIG. 6 shows the incomplete list as it would appear on application 125 installed and running on computer 110. Alternatively, application 125 may be an online solution accessed by a browser running on computer 110.

As an item, such as a photo, is uploaded via mobile device 105, for example, the list displayed on computer 110 and/or MFP 115 is updated to reflect the changes. In addition, users may submit additional information to case folder 305 in formats not supported by one device, such as mobile device 105, but supported by another device, such as MFP 115. Some formats may also be preferred for certain information. For example, while mobile device 105 may be capable of capturing a photo of a document, the clarity of a scanned copy may still be preferred. In the example incident scenario, the employee may receive a list on mobile device 105 similar to that shown in FIG. 4 and may view it by opening case folder 305 on application 125. Application 125 may be locked to the specific establishment or group of establishments such that any employee of the establishment or group of establishments using mobile device 105, computer 110 and/or MFP 115 may be able to see newly created case folder 305 as well as other previously created case folders 305 for that establishment or group of establishments.

As can been seen in the example embodiments shown in FIGS. 4-6, the list may include fields for uploading files from the plurality of devices. In some example embodiments, the list may also include optional information that may be submitted through the plurality of devices. The required information may serve as evidence for incidents and thus may change according to the type of incident being reported. The required information may include a number of files or documents in varying formats such as image files, video files, audio recordings and scanned documents.

Referring back to FIG. 2, at block 230, at least one of the devices captures and sends required information to server 120. Accordingly, the method of capturing, as well as the format of the information, may depend on the functions available at each device. For example, mobile device 105 may be capable of capturing images, video and audio recordings, while capturing information at MFP 115 may make use of the scan function of MFP 115. Computer 110 may upload files from memory or import files from the internet. In some example embodiments, the format of the information that can be submitted for each item on the list is restricted. For example, the Employee Statement item may accept both document files and image files, but the Photo Evidence item may only accept image files. In capturing information, each of the plurality of devices also generates metadata relating to the captured information. Metadata may include a system-generated file name, time stamp, user information, checklist item, case folder information, and/or device information.

In the example incident scenario, the injured employee or another employee may take a photo of the injury using mobile device 105, upload the photo and add any other required information on the list. The employee may then create an Employee Statement detailing the events leading to the fall of the injured employee, including but not limited to the time, date and location of the incident. Depending on the number of employees involved, it will be appreciated that any number of employees may create an Employee Statement. The Employee Statement may be an electronic form to be filled out using computer 110 or MFP 115, or a hard copy form to be manually filled out and scanned using MFP 115. Alternatively, one employee may capture a photo of the injury while another fills out the Employee Statement. In a second example incident scenario, the employee may just create case folder 605 and let another user of application 125, for example a manager or an investigative agent, capture the required information. The investigative agent may then proceed to the area of the incident, open case folder 605 on a different mobile device 105 and add any photo deemed pertinent to the incident, for example.

In some example embodiments, an identifier may be added or appended to the metadata of the captured required information. The metadata, along with the identifier, is then sent together with the required information to allow server 120 to store required information for specific incidents in folders or locations dedicated to the specific incidents.

In some example embodiments, the captured required information is sent to server 120 immediately after being captured. For example, once a photo is taken, it is sent to server 120, while a session is still ongoing and whether or not the user intends to add another item or capture other information. Alternatively, in other example embodiments, the captured required information may be sent to server 120 at the end of the session. This allows a user of the plurality of devices to capture a number of required information and have those required information be sent in bulk to server 120 once application 125 is closed and/or the session is terminated.

At block 240, server 120 receives the required information from the plurality of devices and stores the required information. In some embodiments, server 120 also receives metadata including an identifier that allows server 120 to store the required information, including the metadata, in folders or locations corresponding to those identifiers, which in turn correspond to specific incidents. The identifier also allows server 120 to recognize which list items the received information corresponds to within the folders or locations. As mentioned in the example incident scenario, the employee may capture a photo of the injury using mobile device 105 and upload an Employee Statement using computer 110 or MFP 115. The captured photo and the Employee Statement are then received by server 120. Server 120 may store the required information in one location or folder associated with the incident, case folder 305 in the example incident. For example, in FIG. 3, all information related to an incident of injury at Store 101 would be stored in the folder named “91000-Store 101”. Storing the required information in one case folder 305 allows information from the plurality of devices to be accessible at one central electronic location, regardless of which individual device of the plurality of devices sends the information. This reduces the need to go to multiple electronic and non-electronic storage locations just to find a single piece of information. The case folder 305 may then be viewable by a user of one of the plurality of devices and the required information stored therein visible to a user of one of the plurality of devices. In some example embodiments, while the required information may be sent by any user of the plurality of devices, case folder 305 and the stored required information may only be viewable by a limited number of authorized users of the plurality of devices. For example, while a user may see on their mobile device that a photo has already been submitted as required information, that user may only view the photo itself after entering a passcode. Alternatively, server 120 may store the received required information after tagging the required information with the identifier associated with the incident.

At block 250, server 120 may update the list to indicate the information that has been submitted, and sends the updated list to the plurality of devices. In some example embodiments, server 120 may compare the current number of items in a case folder 305 to a previous number of items in the same case folder 305. If the current number of items is greater than the previously determined number of items in the case folder, server 120 identifies the most recently added item, updates the list and indicates on a displayed list that the item has been submitted.

Server 120 may update the list every time server 120 receives information from at least one of the multiple devices, making the reporting of collection of the required information to complete an incident report near real-time. This allows users to see which information is still pending near real-time and capture or submit the pending information to complete the incident report in a shorter span of time. For example, a case folder 305 may only need one more piece of information in order for the incident report to be completed. A user of one of the plurality of devices who has access to the pending information may see the updated list and may submit the pending information almost immediately, rather than waiting for a notification or another user to inform him or her.

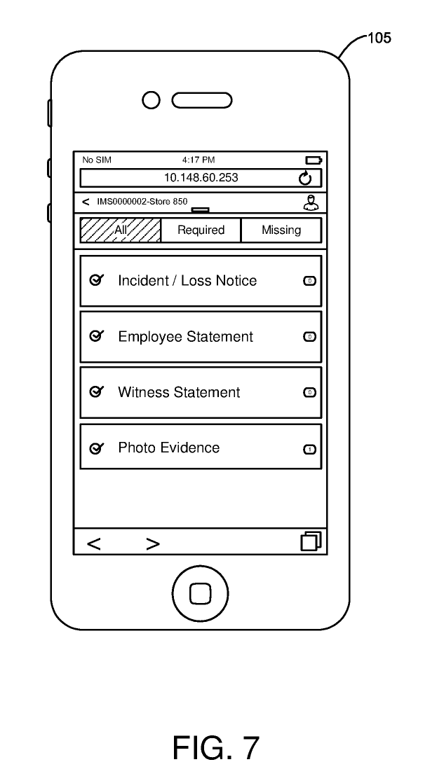

The updated list may include an indication, such as a checkmark, of which required information have already been submitted to and stored by server 120, and which required information are still pending. In some example embodiments, server 120 may also receive an updated list from at least one of the plurality of devices, in addition to the required information. Server 120 then sends this updated list to other devices of the plurality of devices. In the example embodiment shown in FIG. 7, the information that was received and stored by server 120 may be denoted by check marks or ticks beside the item on the list displayed on mobile device 105. In some example embodiments, the updated list is automatically sent simultaneously to the plurality of devices upon server 120 receiving required information at block 240, i.e. in a server push. Server 120 may also notify the users of the plurality of devices that an updated list is available and prompt users to refresh application 125. In other example embodiments, the updated list is sent to one of the plurality of devices in response to a request from one of the plurality of devices, such as refreshing application 125, for example.

Referring back to FIG. 2, at block 260, upon detecting the completion of the required information associated with the incident, server 120 sends a notification to users authorized to review the required information. In some example embodiments, the notification may be an email notification. In other example embodiments, the authorized users may see a display similar to FIG. 6, showing only completed case folders 305 and the notification may come in the form of a new case folder 305 being added to the authorized user's list.

In some example embodiments, server 120 may compare the current number of items stored in one folder to the preset number of items. If the current number of items is equal to the preset number of items, server 120 determines that the required information corresponding to the items are complete and flags each of the required information listed for review. Server 120 may also check that the information corresponding to the items is in the expected format, e.g., image file types for information submitted in Photo Evidence, prior to determining that the required information is complete. In some example embodiments, server 120 may change the state of the folder containing the required information. Server 120 may change an indicator displayed with the folder containing the required information. For example in the embodiment shown in FIG. 3, case folders 305 may be indicated to be “ACTIVE”, meaning the required information is still incomplete, while others may be indicated to be “COMPLETE”, meaning all the required information has been collected.

In some example embodiments, the submitted information may be edited for as long as the case folder 305 is still active, i.e., the required information has not been completed. Users may, for example, upload a clearer scanned copy of a document instead of a previously uploaded photo of the same document. In some example embodiments, the case folder 305 may be locked upon complete submission of all required information for the incident, allowing a user to view the stored information but preventing the addition of more information and the removal or replacement of stored information. The locked folder may be indicated, for example, by a description “COMPLETED—LOCKED” next to the folder name In other example embodiments, the folder may not be locked and additional or optional information may still be sent to server 120 in spite of the required information being complete. In yet other example embodiments, the folder may not be locked immediately upon completion and optional information may still be sent to server 120 for a predetermined time period after the required information has been completed. After the predetermined time period, the folder may then be locked.

In some example embodiments, once the information has been completed, the information in case folder 305 may be used by server 120 to generate a full incident report for sending to relevant agencies, such as police or investigation bureaus and insurance companies, to facilitate any investigations that may require evidence such as the information contained in case folder 305.

It will be appreciated that the actions described and shown in the example flowcharts may be carried out or performed in any suitable order. It will also be appreciated that not all of the actions described in FIG. 2 needs to be performed in accordance with the example embodiments of the disclosure and/or additional actions may be performed in accordance with other embodiments of the disclosure.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing a report for an incident via a remote server, comprising:
receiving an indication of an occurrence of an incident from a first electronic device;
receiving information for a generation of an incident report from at least two electronic devices, the information including one or more data associated with the incident;
storing the information in a storage location associated with the incident;
determining if the stored information includes all information required to generate a complete incident report;
upon a negative determination, transmitting an indication of the stored information and an indication of needed information to generate the complete incident report to at least one of the electronic devices; and
upon a positive determination, changing the state of the storage location associated with the incident and generating the incident report from the stored information associated with the incident,
wherein the changing the state of the storage location associated with the incident report indicates to at least one authorized user that the complete incident report is ready for review.

2. The method of claim 1, wherein the transmitting comprises transmitting the indication of the stored information and of the needed information upon a request by at least one of the electronic devices.

3. The method of claim 1, wherein the transmitting the indication of the stored information and of the needed information occurs automatically upon receiving the information from the at least two electronic devices.

4. The method of claim 1, wherein the storing comprises storing the information in a folder associated with the incident report.

5. The method of claim 1, wherein the storing comprises tagging the information with an identifier associated with the incident report.

6. The method of claim 4, wherein the folder is visible on at least one of the electronic devices to a limited number of authorized users.

7. The method of claim 4, wherein the changing the state of the group associated with the incident report prevents the addition of more information to the folder.

8. The method of claim 4, wherein the changing the state of the group associated with the incident report is the start of a predetermined time period at the end of which no more information associated with the incident report is received and added to the folder.

9. A system for reporting an incident via a plurality of electronic devices, the system comprising:
a first electronics device of the plurality of electronics devices programmed to send information pertaining to an incident for an incident report, the information including one or more data associated with the incident required for the generation and completion of the incident report;
a second electronic device of the plurality of electronics devices programmed to capture and transmit pending information supplementary to the information sent by the first electronic device to a server; and
a server programmed to receive and store the information from the first and second electronic devices and to send an indication of information needed for the generation and completion of the incident report to at least the second electronic device, and to receive the needed information from at least the second electronic device.

10. The system of claim 9, wherein each of the plurality of electronic devices comprises at least one of at least one mobile device, at least one computer and at least one multi-function product.

11. The system of claim 9, wherein the first electronic device is further programmed to capture and transmit pending information supplementary to the information previously sent by the first electronic device.

12. The system of claim 9, wherein the one or more evidence comprises at least one of a document, an image, a video, and an audio recording.

13. The system of claim 9, wherein at least one of the plurality of electronic devices is programmed to capture information by importing the one or more data associated with the incident from the internet.

14. The system of claim 9, wherein the capturing includes importing the one or more data associated with the incident from a memory of the second electronics device.

15. The system of claim 9, wherein the server is further programmed to send an indication of lacking information required for the generation and completion of the incident report to at least one electronic device of the plurality electronic devices upon request.

16. The system of claim 9, wherein the server is further programmed to send an indication of lacking information required for the generation and completion of the incident report to at least one electronic device of the plurality electronic devices upon receiving information from at least one of the plurality of electronic devices.

17. The system of claim 9, wherein the server is further programmed to store the information in one folder associated with the incident report.

18. The system of claim 17, wherein the server is further programmed to change the state of the storage location associated with the incident upon determining the stored information includes all information required to generate and complete the incident report, generate the incident report from the stored information, and to send an indication to at least one authorized user that the incident report is ready for review.

19. The system of claim 18, wherein the change of the state of the storage location associated with the incident report indicates to at least one authorized user that the incident report is ready for review.

20. The system of claim 17, wherein the server is further programmed to prevent the addition of more information to the folder upon incident upon determining the stored information includes all information required to generate and complete the incident report.
